(19) United States
(12) Patent Application Publication
(10) Pub. No.: US 2014/0343203 A1
(43) Pub. Date: Nov. 20, 2014

(54) USE OF ATMOSPHERIC PLASMA FOR THE SURFACE OF INORGANIC PARTICLES AND INORGANIC PARTICLES COMPRISING AN ORGANIC FLUORINE-CONTAINING SURFACE MODIFICATION

(71) Applicant: SOLVAY SA, Brussels (BE)

(72) Inventors: Hans Edouard Miltner, Rhode-st-genese (BE); Eliana Ieva, Alessandria (IT); Valeriy Kapelyushko, Alessandria (IT)

(21) Appl. No.: 14/362,620

(22) PCT Filed: Dec. 5, 2012
(86) PCT No.: PCT/EP2012/074517

§ 371 Date: Jun. 4, 2014

(30) Foreign Application Priority Data
Dec. 5, 2011 (EP) 11191952.8

(51) Int. Cl. C09C 3/10; C08K 9/08; C09C 1/30

(52) U.S. Cl. CPC C09C 3/10; C09C 1/3072; C08K 9/08; C01P 2006/00
USPC 524/148; 570/123; 568/300; 568/28; 568/14; 556/450; 524/545; 524/556; 524/548; 524/560; 524/394; 524/280; 524/155

(57) ABSTRACT

Use of an atmospheric plasma for the surface treatment of inorganic particles selected from the group consisting of particles of metal oxides, particles of metal carbonates, particles of metal sulfates, particles of metal phosphates, acicular particles, platy particles and fibrous particles,with a fluorine-containing precursor.

### CROSS REFERENCE TO A RELATED APPLICATION

This application claims priority to European application No. 11191952.8 , filed Dec. 5, 2011, the whole content of this application being incorporated herein by reference for all purposes.

The present invention relates to certain inorganic particles comprising an organic fluorine-containing surface modification obtainable by treatment of inorganic materials with a fluorine-containing precursor in an atmospheric plasma.

Inorganic particles are widely used in polymer compositions to modify and improve the properties of the same.

Modification of the surface of such inorganic particles has been used to tailor the properties thereof to the polymer compositions or blends where their use is intended. Traditional wet-chemical approaches for the modification of inorganic particles have been developed and are well-known to the skilled person in the art. Generally, such processes make use of organic species non-covalently attached to the inorganic particles from a solution or a melt (surfactants, oligomers, polymers) or of organic species covalently attached or grafted onto the inorganic particles (e.g. alkoxysilanes, phosphonic acid derivatives, azides). The latter approach provides the advantage of ensuring a permanent bond between the particles and the modifier component. This feature should ensure better chemical, thermal and external exposure resistance of treated particles and the final product.

However, the said additional wet-chemical approaches are usually characterized by slow kinetics, making grafting procedures tedious and time consuming. Furthermore, some of the chemicals used, for example the mentioned alkoxysilanes are very expensive and thus prohibitive for most applications for economical reasons.

Plasma is a state of matter similar to gas in which a certain portion of the particles are itemized. Under an applied voltage the gas dissociates into its constituents, leading to ionization of the molecules or atoms of the gas, thus turning it into a plasma, containing neutral species such as gas atoms or molecules and charged particles such as positive ions and negative electrons. The overall charge of a plasma is roughly zero; the charges in a plasma generate electrical currents with magnetic fields, and, as a result they are affected by each other's fields. Charged particles in a plasma must be close enough together that each particle influences many nearby charged particles, rather than just interacting with the closest particle. These collective effects are a distinguishing feature of a plasma.

Plasma approaches for the coating or treatment of extended surfaces such as films, sheets and the like are generally known and described in the art. Generally, the substrate to be treated is immobilized in the treatment atmosphere; the use of the respective devices for the treatment of particulate materials would lead to inhomogeneous surface modifications.

U.S. Pat. No. 5,234,723 discloses a plasma coating process for particulate substrates. Inorganic particles can be used as substrates, silica being expressly mentioned amongst those. FIG. 2 thereof shows the introduction of a particulate material into the afterglow of the plasma and fluoride-containing precursor gases are mentioned amongst a list of potential plasma gases. The plasma is operated at a vacuum of at most 1300 Pa, which requires an expensive set up and such a vacuum to be maintained during operation.

Rubber chemistry and technology 2010, 83 (4) 404-426 relates to the plasma polymerization of monomers onto fillers to tailor the surface properties thereof in higher compositions. The plasma used is a vacuum plasma and fluoride containing precursors are not mentioned.

U.S. Pat. No. 5,759,635 relates to a method of depositing substituted fluorocarbon polymeric layers onto substrates immobilized in the treatment chamber. The plasma used is again a vacuum plasma.

Kautschuk, Gummi, Kunststoffe 2008, 61(10), 502-509 discloses plasma treatment for the compatibilization of fillers and elastomers in compounds to improve their distribution in the product. The plasma used is a vacuum plasma and fluorine-containing treatment gases are disclosed.

The processes and devices of the prior art as described above either suffer from the necessity of having to use a vacuum plasma which is expensive and requires special equipment.

Diamond & Related Materials 16 (2007), 2087 relates to the mere functionalization of the surface of certain nanoparticles having a specific chemical nature and shape, namely nanoparticulate diamond, and of films made thereof, by treatment with a low pressure plasma or an atmospheric pressure dielectric barrier glow discharge plasma. Beyond that the plasma treatment was specifically applied to nanoparticulate diamond materials, Diamond & Related Materials does neither teach nor suggest the capability of an atmospheric plasma treatment of forming a functional coating covering broadly the surface of the treated particles, thereby confering unique properties to these particles.

Ganachaud et al., Langmuir 2011, 27, 4057 describes the tailored grafting of hexafluoropropylene oligomers onto silica nanoparticles by wet chemical processes. Plasma treatment of whatever kind is neither mentioned nor suggested.

WO 2011/144681 relates to polymer compositions comprising a vinylidene fluoride polymer and inorganic particles which are at least partially coated with a polyfluoro polyether block copolymer of a certain structure.

Certain first particles of high interest for their intrinsic properties and commercial accessibility are to be found among particles of metal oxides and particles of metal salts. Certain other particles of high interest for their intrinsic properties and commercial accessibility are to found among particles having a particular shape, characterized by a high aspect ratio; fibers, platelets and needles are representatives thereof.

It is thus an object of the present invention to provide an economic process without the need of expensive equipment or machines which allows for the preparation, starting from certain inorganic particles of high interest for their intrinsic properties, of improved inorganic particles having a surface modification providing unique properties.

It is another object of the present invention to provide certain improved inorganic particles having a surface modification providing unique properties.

These objects are achieved with the use in accordance with claim 1 and with the inorganic particles in accordance with claim 11.

Preferred embodiments of the present invention are disclosed in the dependent claims and the detailed description hereinafter.

Further embodiments of the present invention relate to the use of the inorganic particles of the present invention as fillers in polymer compositions.

The inorganic particles in accordance with the present invention comprise an organic fluorine-containing surface modification obtainable by treatment of inorganic materials with a fluorine-containing precursor under the conditions of an atmospheric plasma.

In a first embodiment, the inorganic particles in accordance with the present invention are of a particular chemical nature: they are selected from the group consisting of particles of metal oxides, particles of metal carbonates, particles of metal sulfates and particles of metal phosphates. In this first embodiment, the inorganic particles for the treatment of which the atmospheric plasma is used in accordance with the present invention may have any shape, i.e. they may e.g. be particulate or fibrous. Quite often, they are particulate. The term particulate in this respect is to be understood as referring to particles having a more or less isometric structure like spherical or nearly spherical particles. Such particulate materials usually differ from acicular or platy compounds as well as fibrous particles in the aspect ratio.

In a second embodiment, the inorganic particles in accordance with the present invention exhibit a high aspect ratio: they are selected from the group consisting of acicular particles, platy particles and fibrous particles. In this second embodiment, the inorganic particles in accordance with the present invention are generally useful as a reinforcing additive, i.e. they increase tensile strength when added to a polymer; the tensile strength can be measured on 3.2 mm (0.125 in) thick ASTM test specimens in accordance with ASTM D-638. Platy particles, acicular particles and fibrous particles, as reinforcing additives, can often provide a high increase in the tensile strength of the polymer compositions.

Platy particles are well known by the persons skilled in the art. Typically, platy particles consist essentially of, or even consist of, particles having the shape of, or resembling to a plate, i.e. the particles are flat or nearly flat and their thickness is small in comparison with the other two dimensions. Certain platy particles are notably described in chapter 17.4.2, p. 926 to 930 of Plastics Additives Handbook, 5^{th} edition, Hanser, the whole content of which is herein incorporated by reference. As referred to hereinafter, the parameter n denotes the refractive index under standard conditions and H denotes the Mohs hardness. The Mohs hardness scale consists of 10 standard minerals starting with talc (Mohs hardness 1) and ending with diamond (Mohs hardness 10). The hardness is determined by finding which of the standard minerals the test material will scratch or not scratch; the hardness will lie between two points on the scale—the first point being the mineral which is scratched and the next point being the mineral which is not scratched. The steps are not of equal value; e.g. the difference in hardness between 9 and 10 is much bigger than between 1 and 2. Non limitative examples of platy particles include talc (n=1.57-1.69, H=1), micas such as muscovite mica (n=1.55-1.61; H ranges from 2.5 to 4) and phlogopite mica (n=1.54-1.69, H=2.5-3), kaolins such as kaolinite (n=1.56-1.61, H=2), calcinated kaolin or mullite (n=1.62, H ranges from 6 to 8, depending on the calcination temperature), and clay such as Bali clay (n=1.6, H=2-2.5).

Acicular particles are also well known by the skilled in the art. Typically, acicular particles consist essentially of, or even consist of, particles having the shape of, or resembling a needle. The acicular particles which may be contained in the polymer composition in accordance with the instant invention, have typically a number average aspect ratio of at least 3.0, up to less than 20. Notably to the purpose of achieving an increased reinforcing effect, the number average ratio of the particles as contained in the polymer composition in accordance with the instant invention, is preferably at least 4.5 and more preferably at least 6.0; when high dimensional stability and low warpage are needed, the number average aspect ratio is preferably at most 15. The number average aspect ratio of the inorganic particles in accordance with the present invention can be determined by optical microscopy coupled with an image analysis software. To this purpose, the particles are advantageously finely dispersed in a solvent such as ethanol. The magnification ranges generally from about 200 to about 400. The image analysis software can be based on Otsu's method as described in “A Threshold Selection Method from Gray-Level Histograms”, IEEE Trans. Syst. Ma, Cybern., 9, 62-66 (1979), the whole content of which is herein incorporated by reference. The number average aspect ratio can be defined as the number average of the aspect ratios of each particle taken individually, and the aspect ratio of a particle can be defined as its length over diameter ratio. The length of a particle can be defined as the length of the major axis of the ellipse having the same normalized second order moment as the particle, while the diameter of the particle can be defined as the length of the minor axis of the ellipse having the same normalized second order moment as the particle.

Among acicular particles, wollastonite (n=1.65, H=4.5-5) and xonotlite (n=1.59, H=6.5) are preferred. Wollastonite is a white calcium metasilicate with good resistance to alkalis; wollastonite is notably described in chapter 17.4.3.1, p. 930 to 931 of Plastics Additives Handbook, 5^{th} edition, Hanser, the whole content of which is herein incorporated by reference. Xonotlite is an inosilicate; typically, its formula is Ca₆Si₆O₁₇(OH)₂. Other acicular particles suitable for the purpose of the present invention include sepiolite, attapulgite and palygorskite particles.

Finally, fibrous particles are also well known by the skilled in the art. Typically, fibrous particles consist essentially of, or even consist of, particles having the shape of, or resembling a fibre, i.e. the particles are slender and greatly elongated, and their length is very high in comparison with the other two dimensions. Notably to the purpose of increased reinforcement, the fibrous particles which are advantageously contained in the polymer composition in accordance with the instant invention, have:
a number average aspect ratio of typically above 5, preferably above 10 and more preferably above 15;
a number average length of typically at least 50 μm, preferably at least 100 μm and more preferably at least 150 μm; and
   a number average diameter of typically below 25 μm, preferably below 20 μm, and more preferably below 15 μm.

Nanoparticulate materials resembling a fibrous shape, in particular carbon based materials, may also be mentioned here. Preferred materials of this type have average medium diameters in the range of from 1 to 100 nm, more preferably of from 10 to 80 nm and most preferably of from 20 to 50 nm. The aspect ratio of respective products preferably exceeds 100, in particular 1000.

As examples for carbon based nanoparticulate materials having a high aspect ratio, so called carbon nanotubes may be mentioned. Carbon nanotubes may be characterized as elongated tubular graphene materials rolled up in cylinders. Graphene materials such as single-layer graphene or so-called nano-graphene platelets are also to be considered as nanoparticulate carbon materials of relevance to the present invention.

In accordance with the present invention, inorganic materials which remain inert during the later processing and use are preferred.

Preferred inorganic particles which can be used in accordance with the first embodiment of the present invention are particles of metal oxides, metal carbonates, metal sulfates and the like. Metal oxides are generally selected among oxides of Ba, Al, Si, Zr, Ce, Ti, Mg, Sn, and mixed oxides comprising these metals in combination with one or more other metals or non-metals; e.g. silica, alumina, zirconia, barium titanate, alumino-silicates (including natural and synthetic clays), zirconates and the like. Metal carbonates are typically selected from the group consisting of alkaline and alkaline earth metal carbonates, e.g. Ca, Mg or Sr carbonates. Metal sulfates are generally selected from alkaline and alkaline earth metal sulfates, including Ca, Mg, Sr and Ba sulfates to mention a few preferred examples.

Other inorganic particles which can be used in accordance with the first embodiment of the present invention are particles of metal phosphates. In the metal phosphates, the one or more metal(s) is (are) generally selected from alkaline metals, alkaline earth metals, aluminum and iron. As herein used, the term <<phosphate>> should be understood in its broadest sense, and includes hydrogenophosphates, polyphosphates such as pyrophosphates and tripolyphosphates, mixed phosphates such as hydroxides-phosphates and halogenos-phosphates, and combinations thereof. Examples of useful metal phosphates are:
calcium orthophosphate [Ca₃(PO₄)₂],
calcium monohydrogenophosphate (CaHPO₄),
calcium dihydrogenophosphate [Ca(H2PO4)₂],
calcium pyrophosphate (Ca₂P₂O₇),
whitlockhites, in particular whitlockhites complying with general formula Ca₉(Mg,Fe)(PO₄)₆(HPO₄),
apatites, in particular apatites complying with general formula Ca₁₀(PO₄)₆(OH,F,Cl,Br)₂, such as hydroxyapatite [Ca₁₀(PO₄)₆(OH)₂], fluoroapatite [Ca₁₀(PO₄)₆(F)₂] and chloroapatite [Ca₁₀(PO₄)₆(Cl)₂].

Core/shell particles, i.e. particles comprising a core and a shell having a composition different from the core may be mentioned as a preferred group of inorganic particles which may be modified in accordance with the present invention.

Silica is a particular preferred inorganic material in accordance with the first embodiment of the present invention.

Fibrous particles in accordance with the second embodiment of the present invention generally have a number average length generally below 30 mm, and a number average diameter generally above 3 μm. Certain fibrous particles are notably described in chapters 17.4.3.2 and 17.4.3.3, p. 930 to 931 of Plastics Additives Handbook, 5^{th} edition, Hanser, the whole content of which is herein incorporated by reference. Among fibrous particles in accordance with the present invention, glass fibre, asbestos, synthetic polymeric fibre, aramid fibre, aluminum fibre, titanium fibre, magnesium fibre, aluminum silicate fibre, silicium carbide fibres, boron carbide fibres, rock wool fibre, steel fibre etc. can be cited. A particular class of fibrous particles consists of whiskers, i.e. single crystal fibres made from various raw materials, such as Al²O₃, SiC, BC, Fe and Ni. Among fibrous particles, glass fibres are preferred; they include chopped strand A-, E-, C-, D-, S- and R-glass fibres, as described in chapter 5.2.3, p. 43-48 of Additives for Plastics Handbook, 2^{nd} edition, John Murphy, the whole content of which is herein incorporated by reference. Depending on their type, glass fibres have a refractive index n of from about 1.51 to about 1.58, and a Mohs hardness H of on average about 6.5.

According to a preferred embodiment of the present invention, the inorganic particles—prior to the plasma treatment—have an average particle diameter of less than or equal to 300 nm, preferably of less than or equal to 200 nm and more preferably of less than or equal to 150 nm. In certain cases it has proven advantageous if the average particle diameter is less than 100 nm, particularly preferred less than 50 nm. Normally, the average particle diameter is of at least 1 nm, or in some cases of at least 3 nm. Such materials are commonly referred to as nanoparticles.

In principle any inorganic material in accordance with the present invention may be preferably used in the form of nanoparticles. Any inorganic particles capable of being manufactured in the size dimensions indicated may be used and respective products or processes for the manufacture are described in the prior art and are known to the skilled person. Carbon based nanoparticles may be mentioned here by way of example.

Graphene or graphene materials like nano-graphene platelets represent one group of carbon-based nanoparticulate materials which may be modified in accordance with the second embodiment of the instant invention. Graphene itself is usually considered as a one-atom thick planar sheet of sp2-bonded carbon atoms that are densely packed in a honeycomb structure. The name graphene is derived from graphite and the suffix -ene. Graphite itself consists of a high number of graphene sheets stacked together.

Graphite, carbon nanotubes, fullerenes and graphene in the sense referred to above share the same basic structural arrangement of their constituent atoms. Each structure begins with six carbon atoms, tightly bound together chemically in the shape of a regular hexagon—an aromatic structure similar to what is generally referred to as benzene.

Recently, a new type of graphene materials, so called nano-graphene platelets or NGP, has been developed and respective products are commercially available, for example from Angstron Materials Inc. NGP refers to an isolated single layer graphene sheet (single layer NGP) or to a stack of graphene sheets (multi-layer NGP). NGPs can be readily mass produced and are available at lower costs and in larger quantities compared to carbon nanotubes. A broad array of NGPs with tailored sizes and properties can be produced by a combination of thermal, chemical and mechanical treatments.

The term average particle diameter when used herein refers to the D₅₀ median diameter computed on the basis of the intensity weighed particle size distribution as obtained by the so called Contin data inversion algorithm. Generally said, the D₅₀ divides the intensity weighed size distribution into two equal parts, one with sizes smaller than D₅₀ and one with sizes larger than D₅₀.

In general the average particle diameter as defined above is determined according to the following procedure. First, if needed, the particles are isolated from a medium in which they may be contained (as there are various processes for the manufacture of such particles, the products may be available in different forms, e.g. as neat dry particles or as a suspension in a suitable dispersion medium. The neat particles are then used for the determination of the particle size distribution preferably by the method of dynamic light scattering. In this regard the method as described in ISO Norm Particles size analysis—Dynamic Light Scattering (DLS), ISO 22412:2008(E) is recommended to be followed. This norm provides i.a. for instructions relating to instrument location (section 8.1.), system qualification (section 10), sample requirements (section 8.2.), measurement procedure (section 9 points 1 to 5 and 7) and repeatability (section 11). Measurement temperature is usually at 25° C. and the refractive indices and the viscosity coefficient of the respective dispersion medium used should be known with an accuracy of at least 0.1%. After appropriate temperature equilibration the cell position should be adjusted for optimal scattered light signal according to the system software. Before starting the collection of the time autocorrelation function the time averaged intensity scattered by the sample is recorded 5 times. In order to eliminate possible signals of dust particles moving fortuitously through the measuring volume an intensity threshold of 1.10 times the average of the five measurements of the average scattered intensity may be set. The primary laser source attenuator is normally adjusted by the system software and preferably adjusted in the range of about 10,000 cps. Subsequent measurements of the time autocorrelation functions during which the average intensity threshold set as above is exceeded should be disregarded.

Usually a measurement consists of a suitable number of collections of the autocorrelation function (e.g. a set of 200 collections) of a typical duration of a few seconds each and accepted by the system in accordance with the threshold criterion explained above. Data analysis is then carried out on the whole set of recordings of the time autocorrelation function by use of the Contin algorithm available as a software package, which is normally included in the equipment manufacturer's software package.

Using such a procedure to determine the average particle diameter provides diameter results for particles taken individually (“primary particles”), i.e. not forming agglomerates or aggregates with other particles. The so-determined average particle diameter is important from a practical point of view, because it influences to a large extent the end use properties confered by the plasma-treated inorganic particles (notably when used as additives in polymer compositions), even if these ones may, to some extent, be available as agglomerates or aggregates of primary particles.

Particles having a small particle diameter as explained before of less than 300 nm are generally referred to as nanoparticles and represent a preferred group of particles in accordance with the present invention. Silica nanoparticles are particularly preferred in certain polymer compositions as will be explained later.

The term atmospheric plasma as used herein refers to a plasma operated and maintained at near atmospheric pressures, i.e. without the need to maintain vacuum conditions. Respective devices for the creation of such plasma conditions are known to the skilled person and described in the literature and thus there are no detailed explanations necessary here. Near atmospheric pressure is intended to cover a preferred pressure range of from 20 000 to 200 000 Pa, preferably of from 40 000 to 160 000 Pa and even more preferably in the range of from 70 000 to 130 000 Pa.

A preferred plasma in accordance with the present invention is a so-called cold plasma. This term is generally used to denote a non-equilibrium plasma having a high electron temperature but a comparatively low gas temperature. Preferred temperatures in accordance with the present invention are in the range of from room temperature to 500° C., preferably in the range of from room temperature to 400° C.

Cold plasma discharges of the preferred type described above can be generated by stationary and pulsed electrical fields. The person skilled in the art knows how to generate respective plasmas.

Plasma temperature is an informal measure of the thermal kinetic energy per particle. The degree of plasma ionization is determined by the electron temperature relative to the ionization energy in a relationship called the Saha equation. At low temperatures, ions and electrons tend to recombine into bound states and the plasma will eventually become a gas.

Because of the large difference in mass, the electrons come to thermodynamic equilibrium amongst themselves much faster than they come into equilibrium with the ions or neutral atoms. For this reason, the ion temperature may be very different from and usually lower than the electron temperature. This is especially common in weakly ionized technological plasma, where the ions are often near the ambient temperature.

Based on the relative temperatures of the electrons, ions and neutrals, plasmas are classified as thermal or non-thermal. Thermal plasmas have electrons and the heavy particles at the same temperature, i.e. they are in thermal equilibrium with each other. Non-thermal plasmas on the other hand have the ions and neutrals at a much lower temperature, whereas electrons are much hotter. Such plasmas are often referred to as cold plasmas.

There are several means for the generation of a plasma, however, one principle is common to all of them: there must be energy input to produce and sustain it.

Most artificial plasmas are generated by the application of electric and/or magnetic fields. Plasmas generated for industrial use can be generally categorized by the type of power source used to generate the plasma (e.g. DC, RF or microwave).

For example, a plasma is generated when an electrical current is applied across a dielectric gas or fluid (an electrically non-conducting material). The potential difference and subsequent electric field pull the bound electrons toward the anode while the cathode pulls the nucleus. As the voltage increases, the current stresses the material beyond its dielectric limits into a stage of electrical breakdown, marked by an electric spark, where the material transforms from being an insulator into a conductor as it becomes increasingly ionized. The first impact of an electron on an atom results in one ion and two electrons. Therefore, the number of charged particles increases rapidly mainly due to a small mean free path. With ample current density and ionization, this forms a luminous electric arc between the electrodes. Electrical resistance along the continuous electric arc creates heat, which ionizes more gas molecules and the gas is gradually turned into a thermal plasma.

Atmospheric plasmas are generally obtained by arc discharge, i.e. a high power thermal discharge of very high temperature which can be generated using various power supplies. Another alternative is a plasma produced by corona discharge, a non-thermal discharge generated by the application of high voltage to sharp tips. Dielectric barrier discharge is a non-thermal discharge generated by the application of high voltages across small gaps wherein a non-conducting coating prevents the transition of the plasma discharge into an arc. In certain applications dielectric barrier discharge has proven to be particularly advantageous to provide the plasma conditions under which the particles in accordance with the present invention may be obtained. Finally, capacitive discharges may be used to produce non-thermal plasmas by the application of radio frequency power to one powered electrode with a grounded electrode held at a small separation distance from the first electrode. Such discharges are commonly stabilized using a noble gas such as a helium or argon or an inert gas such as nitrogen.

Plasmas obtained by using gases like Ar, He or N₂ are preferably used in accordance with the present invention.

A preferred reactor set-up may be described as follows:

Two concentric cylinders act as electrodes to ignite the plasma forming gas fed from the top to the reactor, which plasma is formed between the two concentric cylinders. If needed, the inner cylinder may be cooled with a suitable cooling medium, e.g. water or the like. The plasma is generated through the application of radio frequency power to one of the electrodes.

The inorganic particles to be surface treated may be introduced into the plasma with an appropriate feeding device known to the skilled person and described in the literature. Feeding can be made from the top of the reactor or to the plasma afterglow (as the fluorine containing precursor, see below).

To obtain the desired fluorine-containing surface modification of the inorganic particles, a fluorine-containing precursor has to be fed to the reactor. Preferably, the precursor is added in the area of the plasma afterglow. Thereby, coating the reactor walls with polymerized material can be better avoided.

Other designs and devices for generating an atmospheric plasma are known to the skilled person and he will choose the appropriate set-up in accordance with the specific needs in the specific case. Only by way of example, devices and set-ups as shown and described in EP 651069, BE 1006623, EP 962550, EP 1020892 or EP 1582270 may be mentioned here.

The fluorine-containing precursor providing the fluorine for the modification can be selected from any suitable material providing fluorine to the surface of the inorganic particles under the conditions of the atmospheric plasma. Precursors providing CF₃-groups under the plasma conditions are particularly preferred. Accordingly, preferred precursors are selected from the group consisting of hexafluoropropylene, octafluoropropane, perfluorinated propyl vinyl ether, perfluorinated methyl vinyl ether, perfluorinated methoxydioxole and the like. Even non-CF₃-containing precursors may generate CF₃ moieties in a plasma environment by dissociation and recombination of precursor molecules, e.g. tetrafluoroethylene. CF₃-containing precursors are preferred. The choice of the preferred CF₃-precursor may depend on availability, ease of application, potential for valorization of by-products and especially on the costs. In principle perfluorinated alkoxysilanes could also be used, but due to their very high cost, their use is not preferred for economic reasons.

After treatment with the precursor under the conditions of the atmospheric plasma the inorganic particles comprises a certain amount of CF₃ moieties on its surface in the form of an organic CF3-containing coating. The CF3-containing coating or the CF₃ groups themselves may, but not necessarily have to be attached to the surface of the inorganic particles. Providing a coating containing such groups without such coating being covalently linked to the particles itself provides the desired benefits. If a low surface energy is aimed at, the amount of these moieties should be as high as possible. The amount of such moieties which may be achieved by the plasma process is generally higher than the amount obtainable by wet-chemical processes. Most preferably, the surface is coated with a dense coating of CF₃-moieties as kind of a surface layer on top of the outer surface of the inorganic particles. This way the hydrophobicity of the inorganic particles may be substantially increased which can be advantageous in certain cases when used as additives in polymer compositions.

A content of at least 0.3, more preferably of at least 0.37 CF₃ moieties/nm² has proven to be advantageous in certain cases, in particular in case of using nano-particulate silica as the inorganic particles to be surface-treated.

Another embodiment relates to the use of the inorganic particles in accordance with the present invention as fillers in polymer compositions. As mentioned before, any inorganic material which is known as a filler for polymeric compositions may be used and treated with the plasma process to obtain the inorganic particles in accordance with the instant invention.

Similarly, the type of polymer for which the inorganic particles in accordance with the instant invention may be used is not critical. It may be expected that the plasma treatment and the accompanying surface modification reduces the polarity of the surface of the inorganic particles and thus should reduce the interactions of the inorganic particles with each other in the composition or during incorporation into the composition. This should improve the dispersion of the particles in the polymer and the properties of the composition. It may also be helpful to prevent or at least reduce agglomeration of nano-particulate additives during incorporation into the polymer, which is often undesirable. All these effects are in principle to be expected independently from the type of the polymer. The skilled person will select the polymer based on the intended application and based on his knowledge.

Solvay Specialty Polymers offers a wide range of thermoplastic polymers into which the particles in accordance with the present invention may be introduced and reference is made to the respective products here.

In accordance with a particularly preferred embodiment of the present invention the inorganic particles in accordance with the invention are used in fluorine-containing polymers, in particular in architectural anti-corrosion coatings displaying self-cleaning properties. The increased hydrophobicity of the inorganic particles provides a kind of super-hydrophobicity to the surface of the composition when same is used as a coating for certain substrates. Thus, in accordance with a particularly preferred embodiment of the present invention the inorganic particles are used as additives for vinylidene fluoride (VDF) polymer or copolymer compositions.

The vinylidene fluoride polymer is preferably a polymer comprising:

(a′) at least 60% by moles, preferably at least 75% by moles, more preferably 85% by moles of vinylidene fluoride (VDF);

(b′) optionally from 0.1 to 15%, preferably from 0.1 to 12%, more preferably from 0.1 to 10% by moles of a fluorinated monomer different from VDF; said fluorinate monomer being preferably selected in the group consisting of vinylfluoride (VF1), chlorotrifluoroethylene (CTFE), hexafluoropropene (HFP), tetrafluoroethylene (TFE), perfluoromethylvinylether (MVE), perfluoropropylvinylether (PVE), trifluoroethylene (TrFE) and mixtures therefrom; and

(c′) optionally from 0.1 to 5%, by moles, preferably 0.1 to 3% by moles, more preferably 0.1 to 1% by moles, based on the total amount of monomers (a′) and (b′), of one or more hydrogenated comonomer(s).

The vinylidene fluoride polymer is more preferably a polymer consisting of:

(a′) at least 60% by moles, preferably at least 75% by moles, more preferably 85% by moles of vinylidene fluoride (VDF);

(b′) optionally from 0.1 to 15%, preferably from 0.1 to 12%, more preferably from 0.1 to 10% by moles of a fluorinated monomer different from VDF; said fluorinate monomer being preferably selected in the group consisting of vinylfluoride (VF1), chlorotrifluoroethylene (CTFE), hexafluoropropene (HFP), tetrafluoroethylene (TFE), perfluoromethylvinylether (MVE), perfluoropropylvinylether (PVE), trifluoroethylene (TrFE) and mixtures therefrom.

As non limitative examples of the VDF polymers useful in the present invention, mention can be notably made of homopolymer of VDF, VDF/TFE copolymer, VDF/TFE/HFP copolymer, VDF/TFE/CTFE copolymer, VDF/TFE/TrFE copolymer, VDF/CTFE copolymer, VDF/HFP copolymer, VDF/TFE/HFP/CTFE copolymer and the like.

VDF homopolymer is particularly advantageous for the compositions of the invention.

The melt viscosity of the VDF polymer measured at 232° C. and 100 sec⁻¹ of shear rate according to ASTM D3835 is advantageously at least 5 kpoise, preferably at least 10 kpoise.

The melt viscosity of the VDF polymer measured at 232° C. and 100 sec⁻¹ of shear rate is advantageously at most 60 kpoise, preferably at most 40 kpoise, more preferably at most 35 kpoise.

The melt viscosity of VDF polymer is measured in accordance with ASTM test No. D3835, run at 232° C., under a shear rate of 100 sec⁻¹.

The VDF polymer has a melting point of advantageously at least 120° C., preferably at least 125° C., more preferably at least 130° C.

The VDF polymer has a melting point advantageously of at most 190° C., preferably at most 185° C., more preferably at most 170° C.

The melting point (Tₘ) can be determined by DSC, at a heating rate of 10° C./min, according to ASTM D 3418.

One example of a commercially available PVDF, which is particularly suitable for use in the present composition, is HYLAR® 5000 PVDF (available from Solvay Solexis Inc.).

The choice of the inorganic particles, which may also be used in the form of mixtures of different inorganic particles, in the preferred embodiment is not particularly critical; it is generally understood that inorganic particles which remain inert during VDF polymer processing and use are preferred. Non limitative examples of particles which can be used are notably particles of metal oxides, metal carbonates, metal sulphates and the like. Metal oxides are generally selected among Si, Zr, and Ti oxides and mixed oxides comprising these metals in combination with one or more other metal(s) or non metal(s); e.g. silica, alumina, zirconia, alumino-silicates (including natural and synthetic clays), zirconates and the like. Metal carbonates are typically selected from the group consisting of alkaline and alkaline earth metal carbonates, e.g. Ca, Mg, Ba, Sr carbonates. Metal sulphates are generally selected among alkaline and alkaline earth metal sulphates, including Ca, Mg, Ba, Sr sulphates. A metal sulphate which has provided particularly good result is barium sulphate.

The inorganic particles before treatment with fluorine-containing modifying agent have an average particle size which is generally from 0.001 μm to 2000 μm, preferably from 0.002 μm to 1000 μm, more preferably from 0.01 to 500 μm, and still more preferably from 0.05 μm to 500 μm.

To the aim of maximizing surface area and interfaces with the host VDF polymer, inorganic particles having nanometric dimensions and high surface area are typically preferred.

To this aim, inorganic particles having an average particle size comprised from 1 nm to 250 nm, preferably from 2 to 200, more preferably from 3 to 150 are preferably employed. Particle size is determined as described hereinabove.

According to a preferred variant of the invention, the composition as above described is a coating composition and/or is used for the manufacture of a coating composition, in particular for the manufacture of self-cleaning surfaces. Thus, a facet of the present invention is directed to a substrate on which the polymer composition as above described is coated, and a related facet of the present invention is directed to the use of the polymer composition as above described as self-cleaning coating on a substrate.

The choice of substrate to be coated is not particularly critical or limited. Plastic and metal substrates are illustrative examples, e.g. aluminium, architectural steel profiles and panels but also tiles, tubes pipes or containers may be mentioned. Particularly preferred is the use architectural substrates thus obtaining products having improved self-cleaning surfaces, e.g. surfaces which due to their increased respectively improved hydrophobicity show a reduced dirt uptake.

The thickness of respective coatings is not particularly limited and is adapted to the specific case of application. Preferably, coatings with a thickness in the range of from 5 to 100, preferably of from 10 to 70 and particularly preferably of from 15 to 45 μm may be used.

Suitable coating compositions generally comprise the vinylidene fluoride polymer either at least partially dispersed or at least partially solubilised in a liquid medium.

According to a first embodiment of this variant, the polymer is at least partially dispersed in said liquid medium.

By the term “dispersed” is meant that particles of polymer are stably dispersed in the liquid medium, so that neither settlement into cake nor solvation of the particles does occur during coating or paint preparation and upon storage.

The vinylidene fluoride polymer is preferably substantially in dispersed form that is to say that more that 90% wt, preferably more than 95% wt, more preferably more than 99% wt is dispersed in a liquid medium.

The liquid medium preferably comprises at least one organic solvent selected from intermediate and latent solvents for the polymer. However, water based liquid media may also be used.

An intermediate solvent for the polymer is a solvent which does not dissolve or substantially swell the polymer at 25° C., which solvates the polymer at its boiling point, and retains the polymer in solvated form, i.e. in solution, upon cooling.

A latent solvent for the polymer is a solvent which does not dissolve or substantially swell the polymer at 25° C., which solvates the polymer at its boiling point, but on cooling, the polymer precipitates.

Latent solvents and intermediate solvents can be used alone or in admixture. Mixtures of one or more than one latent solvent with one or more than one intermediate solvent can be used.

Intermediate solvents suitable for the coating composition of this embodiment are notably butyrolactone, isophorone and carbitol acetate.

Latent solvents suitable for the coating composition of this embodiment are notably methyl isobutyl ketone, n-butyl acetate, cyclohexanone, diacetone alcohol, diisobutyl ketone, ethyl acetoacetate, triethyl phosphate, propylene carbonate, triacetin (also known as 1,3-diacetyloxypropan-2-yl acetate), dimethyl phthalate, glycol ethers based on ethylene glycol, diethylene glycol and propylene glycol, and glycol ether acetates based on ethylene glycol, diethylene glycol and propylene glycol.

Non limitative examples of glycol ethers based on ethylene glycol, diethylene glycol and propylene glycol are notably ethylene glycol monomethyl ether, ethylene glycol monoethyl ether, ethylene glycol monopropyl ether, ethylene glycol monobutyl ether, ethylene glycol dimethyl ether, ethylene glycol diethyl ether, ethylene glycol dibutyl ether, diethylene glycol monomethyl ether, diethylene glycol monoethyl ether, diethylene glycol mono-n-butyl ether, propylene glycol methyl ether, propylene glycol dimethyl ether, propylene glycol n-propyl ether.

Non limitative examples of glycol ether acetates based on ethylene glycol, diethylene glycol and propylene glycol are notably ethylene glycol methyl ether acetate, ethylene glycol monethyl ether acetate, ethylene glycol monobutyl ether acetate, propylene glycol methyl ether acetate.

Non-solvents for the vinylidene fluoride polymer such as methanol, hexane, toluene, ethanol and xylene may also be used in combination with latent solvent and/or intermediate solvent for special purpose, e.g. for controlling paint rheology, in particular for spray coating.

Generally, the liquid medium will consist essentially of one or more organic solvents selected from latent solvents and intermediate solvents, as above detailed. Minor amounts (e.g. of less than 5% wt, preferably less than 1% wt) of water or other organic solvents might be present in the liquid medium of the composition.

The vinylidene fluoride polymer can be provided under dispersed form by dispersing a powder of bare polymer, generally an agglomerated powder obtained from latex coagulation and drying, in a liquid medium comprising latent and/or intermediate solvent as above detailed; the coating composition can thus be obtained by mixing said polymer in said dispersed form with the inorganic particles, as above defined, and with all other optional ingredients and additives.

As an alternative, a pre-mixed powder consisting essentially of polymer, of the inorganic particles in accordance with the present invention, and, optionally, of other ingredients, as below detailed, can be manufactured first and used instead of powder of bare polymer.

According to this alternative, said pre-mixed powder is generally obtained by mixing in an aqueous phase a powder of bare polymer, generally an agglomerated powder obtained from latex coagulation, with said inorganic particles, as above detailed, and optionally with said other ingredients, then evaporating the aqueous phase until dryness, at a temperature of at least 50° C., and optionally grinding or sieving the so obtained solid residue in order to obtain a pre-mixed powder, advantageously possessing free-flowing properties.

The choice of the device for dispersing the polymer or the pre-mixed powder in said liquid medium is not particularly limited. High shear mixers or other size-reduction equipment such as high pressure homogenizer, a colloidal mill, a fast pump, a vibratory agitator or an ultrasound device can be used.

Agglomerated powders of polymer particularly suitable are composed of primary particles having an average particle size of preferably 200 to 400 nm and are typically under the form of agglomerates having an average particle size distribution of preferably 1 to 100 μm, more preferably of 5 to 50 μm.

According to another embodiment, the polymer may be at least partially dissolved in a liquid medium.

By the term “dissolved” is meant that the polymer is present in solubilised form in the liquid medium.

The polymer is preferably substantially in dissolved form that is to say that more than 90% wt, preferably more than 95% wt, more preferably than 99% wt are dissolved in the liquid medium.

The liquid medium according to this embodiment preferably comprises an organic solvent selected among active solvents for the vinylidene fluoride polymer.

An active solvent for the polymer is a solvent which is able to dissolve at least 5% wt of the polymer (with respect to the total weight of the solution) at a temperature of 25° C.

Active solvents which can be used in this embodiment are notably acetone, tetrahydrofurane, methyl ethyl ketone, dimethylformamide, dimethylacetamide, tetramethylurea, dimethylsulfoxide, trimethylphosphate, N-methyl-2-pyrrolidone.

When used for coating purposes, the above described compositions of vinylidene fluoride polymers and the inorganic particles in accordance with the instant invention may comprise in addition to the vinylidene fluoride polymer at least one (meth)acrylic polymer. Alternatively, the vinylidene fluoride polymer may be a copolymer of vinylidene fluoride monomers and (meth)acrylic monomers.

Suitable (meth)acrylic polymers typically comprise recurring units selected from the group of formulae j, jj, jjj of formulae:

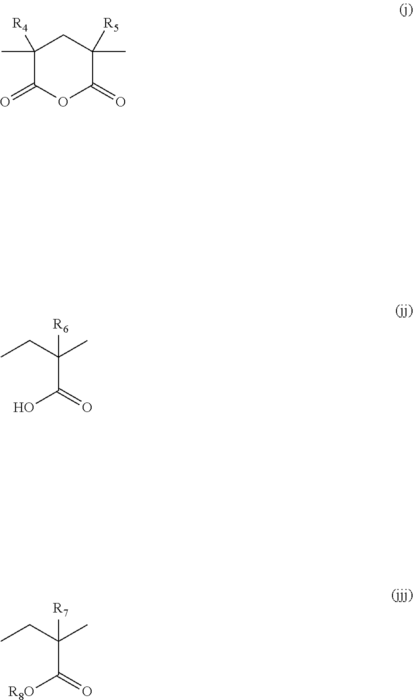

wherein R₄, R₅, R₆, R₇, equal to or different from each other are independently H or C₁₋₂₀ alkyl group, R₈ is selected from the group consisting of substituted or non substituted, linear or branched, C₁-C₁₈ alkyl, C₁-C₁₈ cycloalkyl, C₁-C₃₆ alkylaryl, C₁-C₃₆ aryl, C₁-C₃₆ heterocyclic group.

Preferably, suitable (meth)acrylic acid polymers comprise recurring units of formula j, as detailed above. Optionally the (meth)acrylic acid polymers can comprise additional recurring units different from j, jj, jjj, typically derived from ethylenically unsaturated monomers, such as notably olefins, preferably ethylene, propylene, 1-butene, styrene monomers, such as styrene, alpha-methyl-styrene and the like.

Preferably, the (meth)acrylic acid polymer is a polymer comprising recurring units derived from one or more than one alkyl (meth)acrylate. A polymer which gave particularly good result in certain cases is a copolymer of methyl methacrylate and ethyl acrylate, commercially available under trade name PARALOID™ B-44.

Should the coating composition comprise a (meth)acrylic acid polymer, it is generally comprised in the composition of the invention in a weight ratio (meth)acrylic acid polymer/vinylidene fluoride polymer of 10/1 to 1/10, preferably of 5/1 to 1/5, more preferably of 3/1 to 1/3.

As mentioned above, silica particles are a particularly preferred additive in accordance with the instant invention. Fumed silica nanoparticles which are especially preferred are commercially available from various suppliers and generally have average particle diameters in the range of from 5 to 50 nm and a high specific surface area (preferably exceeding 100 m²/g in accordance with BET at 25° C.). Higher surface areas generally require higher amount of fluorine-containing modification. Suitable silica products are e.g. available under the tradename Aerosil® from Evonik-Degussa.

The type of silica is not particularly relevant and the silica may be mixed with other inorganic materials to improve e.g. gloss (this can be achieved with BaSO₄ to name only one example).

The amount of the inorganic particles in polymer compositions is not particularly critical and will be chosen in accordance with the particular application. In case of an application in the coating area, the amount of inorganic particles is preferably in the range of from 1 to 5 wt %, based on the amount of the polymer.

The inorganic particles as obtainable in accordance with the instant invention provide advantageous properties when mixed with polymers, especially with vinylidene fluoride polymers in coating compositions. They provide a very high hydrophobicity to surfaces coated with the respective compositions which is useful and advantageous for the purpose of self-cleaning surfaces. Accordingly, a preferred use for polymer compositions in accordance with the present invention is the application as a coating for self cleaning surfaces, in particular exterior surfaces of buildings or architectural structures, e.g. architectural steel profiles and panels but also tiles, tubes and pipes.

The fluorinated surface modification generated through the treatment with the atmospheric plasma in accordance with the present invention is usually and preferably polymeric in nature, and can thus be qualified as “fluoropolymer” formed on the surface of the inorganic particles. The term “fluoropolymer” in this context should be understood in its broadest meaning, merely denoting an organic material comprising several fluorine containing repeat units.

The repeat units of a fluoropolymer can be of one or more than one type. Notably, they can be selected from the group consisting of —CF₂—, —CF(CF₃)—, —C(CF₃)₂—, —CHF—, —CH(CF₃)—, —CH₂— and mixtures thereof, provided that at least part of them contain at least one fluorine atom. Preferably, the fluoropolymer includes —CF(CF₃)— and/or —C(CF₃)₂— repeat units. Also preferably, the fluoropolymer surface modification is essentially free of repeat units containing at least one hydrogen atom, especially —CH₂— repeat units.

Frequently and preferably, the fluoropolymer surface modification is poorly soluble, essentially insoluble (essentially insoluble being understood as having a solubility in the respective solvent of less than 0.01 g/l at a temperature of 25° C.) or insoluble in common solvents of fluoropolymers (insolubility being understood as a non-measurable amount of dissolution in the solvent under the conditions of measurement) having the same C/F weight ratio prepared by conventional polymerization processes.

Thus, for example, frequently and preferably, the fluoropolymer surface modification has a solubility in perfluoroheptane at a temperature of 25° C. of less than 20 g/l, more preferably less than 1 g/l, still more preferably less than 0.2 g/l and still still more preferably less than 0.01 g/l; the most preferably, it is insoluble in perfluoroheptane at a temperature of 25° C.

The lack of solubility is an indication of a higher degree of crosslinking in the fluoropolymer surface modification compared to surface modifications obtained by conventional treatment of the inorganic particles. Thus, the fluoropolymer surface modification consists usually and preferably of a crosslinked, in particular a highly crosslinked network of polymer chains. Due to the higher degree of crosslinking the fluoropolymer surface modification has often a higher glass transition temperature than surface modifications obtained through conventional methods without the application of an atmospheric plasma.

The fluoropolymer surface modification of the inorganic particles of the present invention has very often a low degree of crystallinity (i.e. it has a melting point and a glass transition temperature) or is even completely amorphous (having only a glass transition temperature but no melting point), while fluoropolymers having the same C/F weight ratio prepared by conventional coating processes present a substantially higher degree of crystallinity.

While not finally proved, it is believed that the above special, essentially unique attributes of the fluoropolymer surface modification result from the fact that it is produced by the recombination of radical fragments generated by high energy particles in the plasma.

Should the disclosure of any patents, patent applications, and publications which are incorporated herein by reference conflict with the description of the present application to the extent that it may render a term unclear, the present description shall take precedence.

1. A process for modifying the surface of inorganic particles selected from the group consisting of:
particles of metal oxides, particles of metal carbonates, particles of metal sulfates, particles of metal phosphates, acicular particles, platy particles and fibrous particles,
the process comprising treating the inorganic particles with a fluorine-containing precursor under the conditions of an atmospheric plasma.

2. The process in accordance with claim 1 wherein the inorganic particles are selected from the group consisting of particles of metal oxides, particles of metal carbonates and particles of metal sulfates.

3. The process in accordance with claim 2 wherein the inorganic particles are selected from the group consisting of particles of metal oxides.

4. The process in accordance with claim 3 wherein the inorganic particles comprise silica.

5. The process in accordance with claim 1 wherein the inorganic particles are selected from the group consisting of acicular particles, platy particles and fibrous particles.

6. The process in accordance with claim 1, wherein the fluorine-containing precursor is not a CF₃-containing precursor but generates CF₃ moieties in a plasma environment by dissociation and recombination of precursor molecules.

7. The process in accordance with claim 1, wherein the fluorine-containing precursor is a CF₃-containing precursor.

8.-10. (canceled)

11. The inorganic particles obtained by the process according to claim 1, wherein the inorganic particles comprise an organic fluorine-containing surface modification, wherein said organic fluorine-containing surface modification comprises CF₃ groups and is a fluoropolymer, wherein (i) the fluoropolymer consists of a crosslinked network of polymer chains, and/or (ii) the fluoropolymer is insoluble in perfluoroheptane at a temperature of 25° C. or has a solubility in perfluoroheptane at a temperature of 25° C. of less than 20 g/l.

12. (canceled)

13. (canceled)

14. The inorganic particles in accordance with claim 11, wherein the fluoropolymer is completely amorphous.

15. A polymer composition comprising a polymer and inorganic particles obtained by a process for modifying the surface of inorganic particles selected from the group consisting of:
particles of metal oxides, particles of metal carbonates, particles of metal sulfates, particles of metal phosphates, acicular particles, platy particles and fibrous particles,
the process comprising treating the inorganic particles with a fluorine-containing precursor under the conditions of an atmospheric plasma, and the inorganic particles in accordance with claim 11.

16. The polymer composition in accordance with claim 15 wherein the polymer is a vinylidene fluoride polymer.

17. The polymer composition in accordance with claim 16 additionally comprising at least one (meth)acrylic polymer [polymer (M)] comprising recurring units selected from the group of formulae j, jj, jjj of formulae: 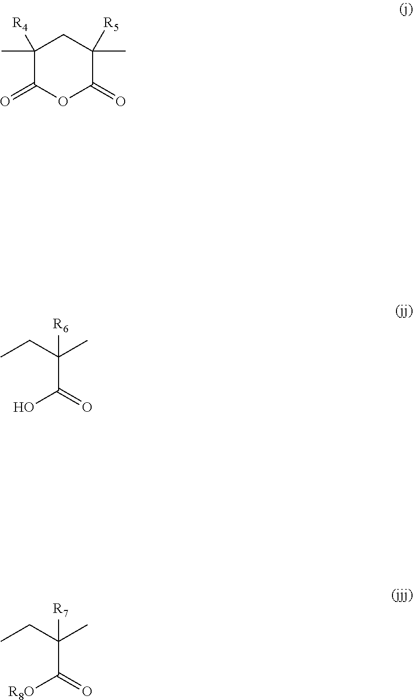
wherein R₄, R₅, R₆, R₇, equal to or different from each other, are independently H or C₁₋₂₀ alkyl group, R₈ is selected from the group consisting of substituted or non substituted, linear or branched, C₁-C₁₈ alkyl, C₁-C₁₈ cycloalkyl, C₁-C₃₆ alkylaryl, C₁-C₃₆ aryl, C₁-C₃₆ heterocyclic group.

18. (canceled)

19. A substrate on which the polymer composition in accordance with claim 15 is coated.

20. A self-cleaning coating on a substrate, the coating comprising the polymer composition in accordance with claim 15.

21. The process in accordance with claim 3 wherein the inorganic particles consist essentially of silica.

22. Inorganic particles selected from the group consisting of:
particles of metal oxides, particles of metal carbonates, particles of metal sulfates, particles of metal phosphates, acicular particles, platy particles and fibrous particles,
wherein said inorganic particles comprise an organic fluorine-containing surface modification, wherein the organic fluorine-containing surface modification is a fluoropolymer, wherein the fluoropolymer is insoluble in perfluoroheptane at a temperature of 25° C. or the fluoropolymer has a solubility in perfluoroheptane at a temperature of 25° C. of less than 20 g/l.

23. The inorganic particles according to claim 22, wherein the fluoropolymer is insoluble in perfluoroheptane at a temperature of 25° C. or has a solubility in perfluoroheptane at a temperature of 25° C. of less than 0.2 g/l.

24. The inorganic particles according to claim 22, wherein the fluoropolymer consists of a crosslinked network of polymer chains.

25. The inorganic particles according to claim 22, wherein the fluoropolymer is completely amorphous.

26. The inorganic particles according to claim 22, wherein the fluoropolymer comprises CF₃ groups.
